(19) United States
(12) Patent Application Publication
(10) Pub. No.: US 2008/0172406 A1
(43) Pub. Date: Jul. 17, 2008

(54) Preference data generation device, content display device, preference data generation method and recording medium

(75) Inventors: Tomonori Takeda, Kawasaki (JP); Tetsuo Yamaguchi, Kawasaki (JP); Daijoh Nakayama, Kawasaki (JP); Takeshi Yoshida, Kawasaki (JP); Shigeaki Oura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/000,331

(22) Filed: Dec. 11, 2007

(30) Foreign Application Priority Data
Jan. 15, 2007 (JP) 2007-5453

(51) Int. Cl. G06F 17/00; G09G 5/00

(52) U.S. Cl. 707/102; 345/1.1; 707/E17.009; 345/204

(57) ABSTRACT

There is provided a preference data generation device for generating preference data of a viewer pertinent to content to be displayed in a content display screen area that is one of a plurality of screen areas displayed on a display unit in an information processing system apparatus provided with the display unit, the device including a state information acquisition unit that acquires state information pertinent to the plurality of screen areas displayed on the display unit; a preference evaluation value calculation unit that calculates a preference evaluation value pertinent to the content, based on the state information acquired by the state information acquisition unit; and a preference data generation unit that generates preference data pertinent to the content, based on the preference evaluation value calculated by the preference evaluation value calculation unit.

### PREFERENCE DATA GENERATION METHOD AND RECORDING MEDIUM

This application is related to and claims priority to Japanese patent application No. 2007-5453 filed on Jan. 15, 2007, in the Japan Patent Office, and incorporated by reference herein.

### BACKGROUND OF THE INVENTION

1. Field of the Invention

The present invention relates to a technique of generating preference data of a viewer pertinent to content displayed in one of a plurality of screen areas displayed on a display unit in an information processing system provided with the display unit.

2. Description of the Related Art

In recent years, in an image recording/playback device such as a digital versatile disk (DVD) recorder or a hard disk drive (HDD) recorder that is capable of receiving a TV program and recording an image, there has been known equipment for determining a user's preference based on a history such as the user playback history or image recording history, and automatically recording a program as an image that is suitable for the user's preference or providing an auto image recording function of an associated program with keyword entry.

In recent years, an available method has also been generally known, wherein a personal computer (PC) is provided with a broadcast receiving function such as a TV tuner, and a received or recorded TV program is displayed and viewed in one of multiple windows displayed on a display.

In such an information processing apparatus capable of displaying multiple windows, another process can be executed in parallel together with display of a TV program.

However, in such an information processing unit capable of executing another process in parallel together with display of a TV program, even if TV displaying or recorded data playback is in progress, a user (viewer) does not watch a TV program or playback data in some cases.

For example, assume that a TV program is being displayed in one window on a PC. Even in this event, a Web browser may be executed in another window on the PC and a user may watch the Internet browsing to be performed with the use of the Web browser. In such a case, there is a danger of causing incorrect recognition that the displayed TV program is adaptive to a user's preference in determining/analyzing preference in accordance with, for example, a playback (display) time of contents. Therefore, it is impossible to say that the TV program being played back is adaptive to the user's preference.

In other words, in a conventional preference analysis method of, based on a history of a browsing operation by a user in TV display or recorded data playback, determining preference to the content, it is difficult to fully analyze the user's preference. Moreover, in the conventional preference analysis technique based on the fact the content (TV program) is displayed, it is impossible to fully analyze the user's preference.

The present invention has been achieved in view of such a problem. It is an object of the invention to enable precise and sufficient analysis of a viewer's preference pertinent to content to be displayed, even in an information processing apparatus capable of displaying multiple screen areas.

### SUMMARY OF THE INVENTION

Various embodiments of the present invention provide a preference data generation device for generating preference data of a viewer pertinent to a content to be displayed in a content display screen area that is one of a plurality of screen areas displayed on a display unit in an information processing system apparatus provided with the display unit, the device including: a state information acquisition unit that acquires state information pertinent to the plurality of screen areas displayed on the display unit; a preference evaluation value calculation unit that calculates a preference evaluation value pertinent to the content, based on the state information acquired by the state information acquisition unit; and a preference data generation unit that generates preference data pertinent to the content, based on the preference evaluation value calculated by the preference evaluation value calculation unit.

Various embodiments of the present invention provide a content display device including a display unit capable of displaying a plurality of screen areas; a display control unit capable of displaying a content in a content display screen area that serves as one screen area of the plurality of screen areas; a state information acquisition unit that acquires state information pertinent to the plurality of screen areas displayed on the display unit; a preference evaluation value calculation unit that calculates a preference evaluation value pertinent to the content, based on the state information acquired by the state information acquisition unit; and a preference data generation unit that generates preference data pertinent to the content, based on the preference evaluation value calculated by the preference evaluation value calculation unit.

Various embodiments of the present invention provide a preference data generation method for generating preference data on a viewer pertinent to content displayed in a content display screen area that is one screen area of a plurality of screen areas displayed on a display unit in an information processing apparatus including the display unit, the method including acquiring state information pertinent to the plurality of screen areas displayed on the display unit; calculating a preference evaluation value pertinent to the content, based on the state information acquired; and generating preference data pertinent to the content, based on the preference evaluation value calculated.

Various embodiments of the present invention provide a preference data generation program for causing a computer to execute a preference data generation function of generating preference data of a viewer pertinent to content displayed in a content display screen area that serves as one screen area of a plurality of screen areas displayed on a display unit, the program causing the computer to function as a state information acquisition unit that acquires state information pertinent to the plurality of screen areas displayed on the display unit; a preference evaluation value calculation unit that calculates a preference evaluation value pertinent to the content, based on the state information acquired by the state information acquisition unit; and a preference data generation unit that generates preference data pertinent to the content, based on the preference evaluation value calculated by the preference evaluation value calculation unit.

According to various embodiments of the invention, any one of the following advantageous effects and advantages can be obtained.

State information pertinent to multiple screen areas displayed on a display unit is acquired, a preference evaluation value pertinent to content is calculated based on the state information, and preference data is generated based on the preference evaluation value, whereby preference data reflecting a viewer's preference can be generated.

A preference reference value pertinent to content is calculated based on an operation history associated with display of the content in an information processing apparatus, and preference data is generated based on the calculated preference reference value and preference evaluation value, whereby more precise preference data reflecting a viewer's preference can be generated.

Equipment process state information pertinent to a process to be executed in an information processing apparatus is acquired, and a preference evaluation value is calculated based on the equipment process state information, whereby the preference evaluation value can be easily and reliably calculated and it is possible to generate more precise preference data reflecting a viewer's preference suitable for the state of the information processing apparatus.

State information can be easily acquired by content display screen area display information pertinent to a display state of a content display screen area in a display unit or screen area process state information indicative of a process state pertinent to multiple screen areas in an information processing apparatus.

The above examples are only examples of various embodiments of the present invention. All embodiments are not limited to including the features of these examples.

### BRIEF DESCRIPTION OF THE DRAWINGS

FIG. 1 is a diagram schematically depicting a functional configuration of an information processing apparatus according to one embodiment of the invention;

FIG. 2 is a diagram schematically depicting an exemplary hardware configuration of the information processing apparatus according to an embodiment of the invention;

FIG. 3 is a view showing an exemplary display screen of a display of the information processing apparatus according to an embodiment of the invention;

FIG. 4 is a flow chart explaining an exemplary method of acquiring equipment process state information by means of an equipment process state information acquisition unit of the information processing apparatus according to an embodiment of the invention;

FIG. 5 is a flow chart explaining the method of acquiring state information by means of the state information acquisition unit of the information processing apparatus according to an embodiment of the invention;

FIG. 6 is a diagram for explaining a method of calculating a preference evaluation value by means of a preference evaluation position calculation unit in the information processing apparatus according to an embodiment of the invention;

FIG. 7 is a diagram for explaining the method of calculating a preference evaluation value by means of the preference evaluation position calculation unit in the information processing apparatus according to an embodiment of the invention;

FIG. 8 is a diagram for explaining the method of calculating a preference evaluation value by means of the preference evaluation position calculation unit in the information processing apparatus according to an embodiment of the invention;

FIG. 9 is a diagram for explaining the method of calculating a preference evaluation value by means of the preference evaluation position calculation unit in the information processing apparatus according to an embodiment of the invention;

FIG. 10 is a diagram for explaining the method of calculating a preference evaluation value by means of the preference evaluation position calculation unit in the information processing apparatus according to an embodiment;

FIG. 11 is a diagram for explaining a method of generating a preference value in the information processing apparatus according to an embodiment;

FIG. 12 is a flow chart for explaining a preference analysis technique at the time of displaying a TV program in the information processing apparatus according to an embodiment;

FIG. 13 is a diagram showing a functional configuration for implementing a notification function in the information processing apparatus according to an embodiment; and

FIG. 14 is a flow chart for explaining a method of notifying of event detection at the time of displaying a content in the information processing apparatus according to an embodiment.

### DETAILED DESCRIPTION OF THE EMBODIMENTS

Hereinafter, various embodiments of the present invention will be described with reference to the accompanying drawings.

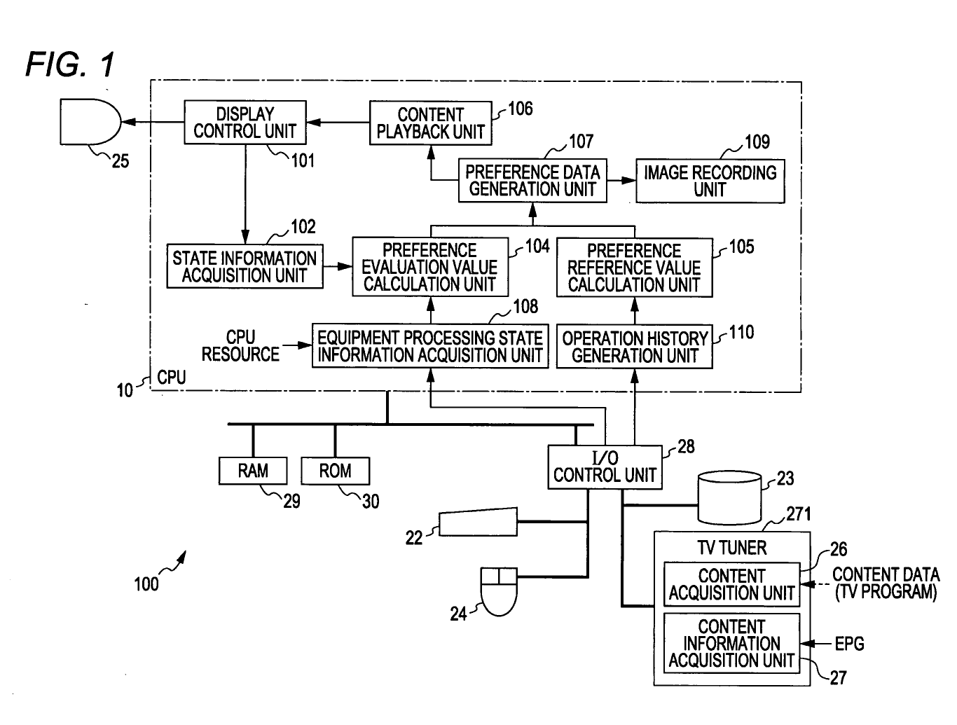

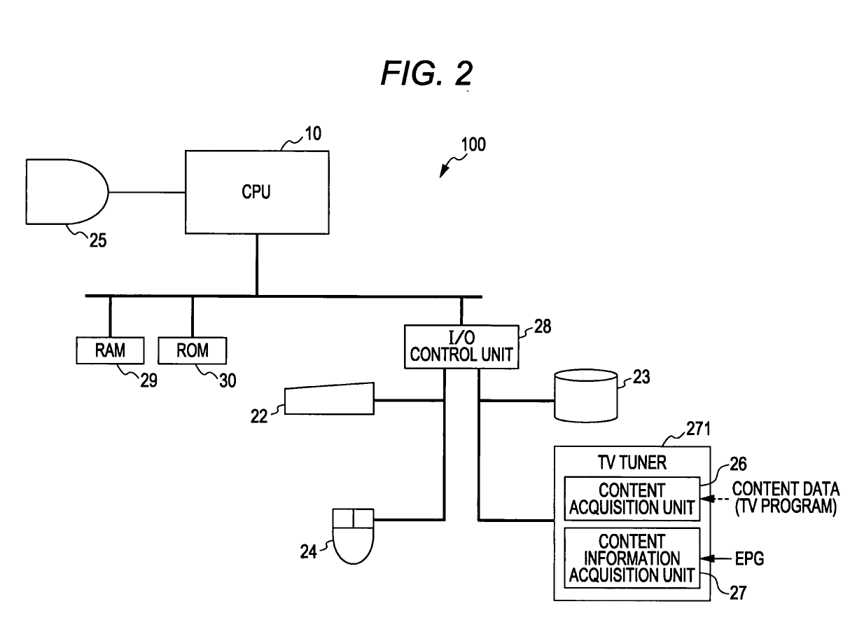

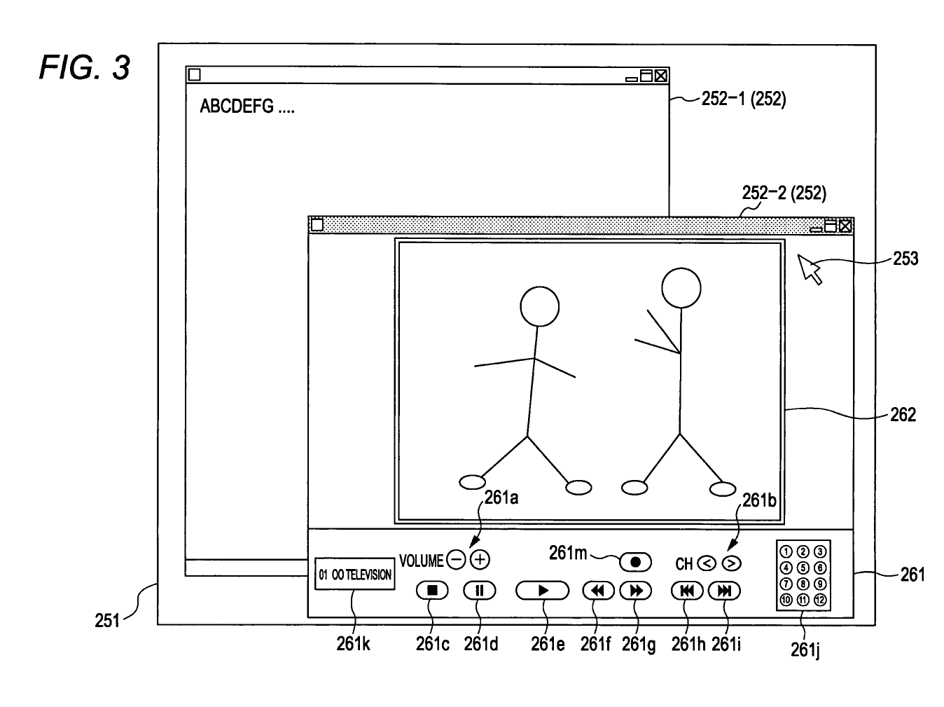

FIG. 1 is a diagram schematically depicting a functional configuration of an information processing apparatus according to an embodiment of the invention; FIG. 2 is a diagram schematically depicting an exemplary hardware configuration of the apparatus; and FIG. 3 is a view showing an example of a display screen 251 of a display 25 of the apparatus.

The information processing apparatus (preference data generation device, content display device) 100, for example, as shown in FIG. 2, is configured to include a CPU 10, an I/O control unit 28, a keyboard 22, an HDD 23, a mouse 24, a display 25, a TV tuner 271, a RAM 29, and a ROM 30, and is configured as a computer system capable of executing a plurality of processes in parallel.

The display 25 serves to display a variety of information or contents in accordance with the control of a display control unit 101 described later, and for example, is implemented by a cathode ray tube (CRT) display or a liquid crystal display (LCD).

The information processing apparatus 100, as shown in FIG. 3, displays multiple windows (screen areas) 252 (two windows in the example shown in FIG. 3) on a display screen 251 of the display 25, and has a multi-window function of enabling capable of executing processes different from each other independently in these multiple windows 252. The multi-window function enables processes that are independent of each other to be performed in the multiple windows 252 displayed on the display screen 251. In addition, an input device such as the keyboard 22 or mouse 24 described later may be used to perform operations such as an input operation and a selection operation independently in these multiple windows 252.

Examples of the multi-window function include those which are substantially integrated with the operating system (OS), like Microsoft Windows (registered trademark), and those which are separated from the OS like the X Windows System for use in the OS of the UNIX system (registered trademark).

In the information apparatus 100, contents such as motion images can be displayed (played back) in at least one window 252 of the multiple windows 252 displayed on the display screen 251.

The example shown in FIG. 3 shows a state in which two windows 252-1, 252-2 are displayed on the display screen 251 and a word processor (program) is being executed in the window 252-1 while a TV program display program is being executed in the window 252-2 (content display screen area).

Hereinafter, reference numerals 252-1, 252-2 indicative of windows are employed when it is necessary to specify one of multiple windows, whereas reference numeral 252 is employed in case of referring to an arbitrary window.

In the example of FIG. 3, the window 252-2 of the two windows 252-1, 252-2 displayed on the display screen 251 is active (active window), wherein at least part of the window 252-1 and the window 252-2 is laid out so as to be superimposed, and part of the window 252-1 is hidden by the window 252-2.

In the information processing apparatus 100, a TV program display program capable of displaying a TV program (video, motion image) is configured in an executable manner, so that a TV program is displayed on the window 252-2 as a result of execution of the TV program display program. Hereinafter, that a TV program is displayed on the window 252-2 as a result of execution of a TV program display program occasionally denotes that a TV program display program is being executed in the window 252-2.

The window 252-2 in which the TV program display program is being executed includes an operation area 261 and a TV program display area 262, for example, as shown in FIG. 3. The TV program display area 262 serves as an area for displaying a TV program, on which the TV program (contents) received by the TV tuner 271 (content acquisition unit 26, content information acquisition unit 27) described later is displayed as a motion image. In the present embodiment, contents are motion images such as cinemas or TV programs, and are broadcasted/distributed via a broadcasting radio wave or the Internet, or alternatively, are provided by various media such as DVDs.

Hereinafter, in the present embodiment, a description will be given with respect to an example in which a content is a TV program distributed by TV broadcasting, and the TV program received by the TV tuner 271 is displayed on the window 252-2 of the multiple windows 252 displayed on the display screen 251.

The operation area 261 is configured to include a variety of buttons for performing operations of a TV program displayed on the TV program display area 262. In the example shown in FIG. 3, the operation area 261 includes a volume button 261a, channel selection buttons 261b, 261j, a stop button 261c, a pause button 261d, a play button 261e, a rewinding button 261f, a fast-feed button 261g, skip buttons 261h, 261i, a channel display part 261k, and an image recording button 261m.

The volume button 261a serves to control volume of a voice in a TV program that is displayed in the TV program display area 262, and the play button 261e serves to play back (display) from the continual of a video that has been stopped. The stop button 261c serves to stop display of a video, the rewinding button 261f serves to rewind a video, and the fast-feed button 251g serves to fast feed a video, respectively.

The pause button 261d serves to suspend, so that a video is stopped while it is displayed during video playback. The skip buttons 261h, 261i serve to skip and play back a video in a backward direction or in a forward direction for a predetermined period of time (for example, 5 seconds). The skip button 261h serves to skip and play back a video in a backward direction and the skip button 261i serves to skip and play back a video in a forward direction, respectively.

The channel selection buttons 261b, 261i serve to select channels, respectively. The channel selection button 261j serves to select a channel by directly inputting a desired channel number with numeric keypad input, and the channel selection button 261b serves to select a channel by sequentially switching channels.

The image recording button 261m serves to image-record a selected video. Depressing/selecting the image recording button 261m allows an image recording unit 109 described later to start image recording of a TV program of a channel selected by the channel selection buttons 261b, 261j. A channel number being received and the related broadcast channel number are displayed on the channel display part 261k.

Operations for selecting/inputting the volume button 261a, channel selection buttons 261b, 261j, stop button 261c, pause button 261d, play button 261e, rewinding button 261f, fast-feed button 261g, skip buttons 261h, 261i, channel display part 261k, and image recording button 261m in the operation area 271 are performed by operating a pointer 253 with the use of an input device such as the mouse 24.

With respect to a variety of input operations performed in the operation area 261f, histories (operation histories) thereof are maintained by an operation history generation unit 110 described later.

A word processor (program) is executed in the window 252-1, so that a user can input a sentence with the use of the keyboard 22 or mouse 24 in the window 252-1 in which the word processor has been executed.

In the word processor executed in the window 252-1, characters can be input with the use of an input device such as the keyboard 22 only in a state in which the window 252-1 is active.

The TV tuner 271 serves as a receiver unit capable of receiving a TV program (contents) to be broadcasted via a broadcasting radio wave via, for example, an antenna (not shown), and functions as a content acquisition unit 26 for acquiring data of contents (data on contents). The TV tuner 271 also functions as a content information acquisition unit 27 for acquiring information pertinent to the contents acquired by another content acquisition unit 26 for acquiring a TV program.

An EPG (Electronic Program Guide), for example, can be employed as program information, and the TV tuner 271 (content information acquisition unit 27) acquires program information such as a program name or a broadcast time by receiving ADAMS-EPF, etc. to be distributed as a data broadcast.

The keyboard 22 and the mouse 24 serve as input devices for a user (operator, viewer) of the information processing apparatus 100 to input a variety of information or input an operation. The keyboard 22 is an input device for inputting characters, and the mouse 24 is an input device for moving the pointer 253 displayed on the display screen 251 to perform a variety of selection operations or window operations (such as size change or move).

The user inputs characters in the window 252-1 in which a word processor has been executed, for example, with the use of the keyboard 22; and performs switching operation of the multiple windows 252 or inputs operations such as size change or move of the window 252 and volume control, fast feed, rewinding, playback, and stop in the window 252-2 in which a TV program display program has been executed, for example, with the use of the mouse 24.

The HDD 23 serves as a storage device capable of storing the OS (Operating System), a variety of applications, and a variety of data etc., and further stores (records) the data on the TV program received by the TV tuner 271 or the operation history generated by the operation history generation unit 110 described later.

The input/output (I/O) control unit 28 serves to control an input/output device in the information processing apparatus 100, such as the keyboard 22, mouse 22 and HDD 23 described above. For example, the control unit serves to deliver the information inputted from the keyboard 22 or mouse 24 to the CPU 10, the device process state information acquisition unit 108 or the operation history generation unit 110, deliver to the CPU 10 a variety of data received by the TV tuner, or control writing into or readout from the HDD 23.

The ROM 30 serves to store a variety of data or programs. The CPU 10 executes a variety of functions with the use of the programs or data stored in the ROM 30 or HDD 23.

The RAM 29 serves to temporarily store a variety of data and programs, and for example, is used to temporarily decompress a variety of data or programs when the CPU 10 performs a computation process.

The central processing unit (CPU) 10 achieves a variety of functions by performing a variety of computation processes, based on the programs or data stored in the ROM 30 or the HDD 23.

The information processing apparatus 100 has a preference data generation function of generating preference data of a viewer (user) pertinent to a TV program displayed in the window 252-2 that serves as one screen area of multiple windows 252 displayed on the display screen 251 of the display 25, and also has a notification function of, if a predetermined event has been detected, notifying the user of the fact in the TV program displayed in the window 252-2.

First, the preference data generation function in the information processing apparatus 100 will be described here.

FIG. 1 is a diagram showing a functional configuration for achieving the preference data generation function in the information processing apparatus 100. The CPU 10 functions as the display control unit 101, a state information acquisition unit 102, a preference evaluation value calculation unit 104, the equipment process state information acquisition unit 108, a preference reference value calculation unit 105, a preference data generation unit 107, a content playback unit 106, the image recording unit 109, and the operation history generation unit 110, as shown in FIG. 1, in order to achieve the preference data generation function.

The content playback unit 106 serves to play back data on a content acquired by the content acquisition unit 26. In the present embodiment, the playback unit is achieved by the CPU 10 executing the TV program display program described previously. Then, the content played back by the content playback unit 106 is displayed in the window 252-2.

The display control unit 101 serves to make control for displaying multiple windows 252 on the display screen 251 of the display 25 or displaying a variety of information on the windows 252. The control unit performs various controls for displaying the contents played back by the content playback unit 106 on the TV program display area 262 of the window 252-2.

When a content is displayed in the window 252-2, a variety of settings such as size of the window 252-2 or its position, a playback volume, a language type of voice (in the case where playback is possible in multiple languages), a language type of subtitle to be displayed (in the case where a subtitle of multiple languages can be displayed) are stored in the HDD 23 as content display setting information. The content playback unit 106 and the display control unit 101 check whether or not content display setting information is stored in the HDD 23 or the like when a content is displayed on the display 25. In the case where the content display setting information exists, these units serve to display the content based on the content display setting information.

The default settings obtained when arbitrary settings are provided as content display setting information are also stored in the HDD 23. With respect to contents of which content display setting information is not set, the default settings are acquired and applied as content display setting information from the HDD 23.

The operation history generation unit 110 serves to generate, as an operation history, a history of operations performed by the user with the use of the keyboard 22 or mouse 24. For example, assume that the data on contents played back by the content playback unit 106 is being displayed. During this event, the user may perform various operations such as volume change or fast feed and rewinding in the operation area 261f with the use of an input device such as the mouse 24. With respect to these operations, information such as the contents or count of these operations may be generated as an operation history, and then, the generated information may be stored in the storage area such as the HDD 23 or the RAM 29 after being associated with information for specifying the contents.

For example, in the case where the content playback unit 106 plays back a content such as a TV program temporarily recorded in the HDD 23 etc., the operation history generation unit 110 records the playback count (display count) as well.

The preference reference value calculation unit 105 serves to calculate a preference reference value pertinent to a content, based on an operation history associated with display of the content in the information processing apparatus 100. This calculation unit serves to acquire the operation history generated by the operation history generation unit 110 to calculate the preference reference value based on the operation history.

The preference reference value used here denotes a value (numeric value) representative of a user's preference relative to the associated contents, and denotes a value generated based on an operation history of an operation performed by the user in the middle of displaying the content.

For example, assume that while a content is displayed in the TV program display area 262, the user operates the volume button 261a to increase a playback volume in the display screen 251, operates the image recording button 261m to perform image recording, or operates the rewinding button 261f or the skip button 261h to perform rewinding. In such a case, it is determined that the degree of the user's preference is high, and the preference reference value increases.

On the other hand, assume that while a content is displayed in the TV program display area 262, the user operates the volume button 261a to reduce the playback volume and operates the fast-feed button 261g or the skip button 261i to perform fast feed. In such a case, it is determined that the degree of the user's preference is low and the preference reference value is reduced.

A variety of known techniques can be employed as a method of calculating a preference reference value by the preference reference value calculation unit 105. In the present embodiment, the preference reference value is calculated as a function F that is based on a coefficient set based on an operation history. The preference reference value used here is occasionally indicated as a function F(α) or a function F. α used here serves as a coefficient generated with an operation history (for example, input/selection operation performed by the user in a screen such as display screen 251), and can be varyingly set.

The equipment process state information acquisition unit 108 serves to acquire equipment process state information pertinent to a process executed in the information processing apparatus 100. The equipment process state information used here denotes information indicative of a variety of hardware-like or software-like states that are varied by executing a process in the information processing apparatus 100. For example, a use level of resources (CPU resources) of the CPU 10 or access quantity (data transfer quantity) to the HDD 23 is employed.

The access quantity to the HDD 23 can be expressed, for example, with the use of a Write time/Write Byte for the HDD 23. The equipment process state information acquisition unit 108 can acquire equipment process state information from equipment such as the CPU 10 or I/O control unit 28.

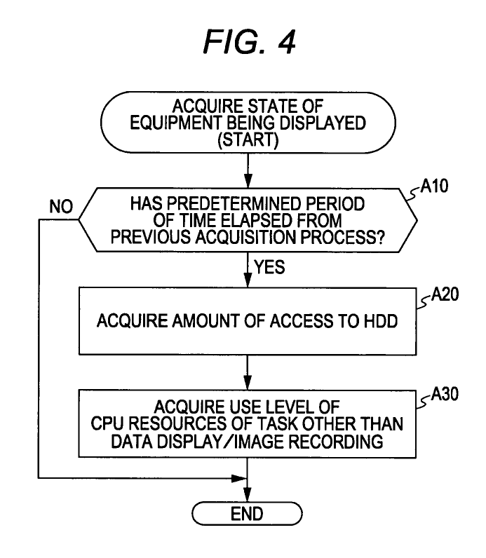

Hereinafter, with reference to the flow chart shown in FIG. 4 (steps A10 to A30), a description will be given by way of example of a method for acquiring equipment process state information by the equipment process state information acquisition unit 108 of the information processing apparatus 100 according to an embodiment of the invention.

The equipment process state information acquisition unit 108 determines an elapsed time after equipment process state information has been acquired immediately before (step A10). In the case where the predetermined period of time has elapsed after the immediately preceding acquisition process (refer to YES route in step A10), the HDD 24 access quantity is acquired from equipment such as the I/O control unit or CPU 10 (step A20). Then, the use level (use rate) of resources of the CPU 10 (CPU resources) is acquired, the use rate (unit: %) of the CPU resources is acquired as to a task pertinent to software other than the TV program display program executed in the window 252-2.

On the other hand, in the case where the predetermined period of time has not elapsed after the immediately preceding acquisition process (refer to NO route in step A10), processing is terminated. This is because, in the case where the predetermined time has not elapsed after the immediately preceding acquisition process has completed, equipment process state information does not vary much.

The HDD 23 access quantity or the use level of the CPU resources, acquired by the equipment process state information acquisition unit 108, is stored, for example, in the HDD 23 or the RAM 29, or any other storage device (not shown).

In the flow chart shown in FIG. 4, the sequential order of performing the process according to step A20 and the process according to step A30 is not limited thereto, and the process according to step A30 may be followed by that according to step S20.

Further, when the equipment process state information acquisition unit 108 employs information other than these CPU resources or access quantity to the HDD 23 as equipment process state information, the equipment process state information can be acquired with an arbitrary timing.

The state information acquisition unit 102 serves to acquire state information pertinent to the window 252 displayed on the display screen 251 of the display 25. The state information used here denotes a display state of the window 252 displayed on the display screen 251 of the display 25. In the present embodiment, this state information includes content display screen area display information pertinent to the display state of the window 252-2 in which a content has been displayed, of the multiple windows 252 displayed on the display screen 251 or screen area process state information indicative of a processing state pertinent to the multiple windows 252 in the information processing apparatus 100.

The content display screen area display information denotes the state (such as window size or active/inactive state) of the window 252-2 displaying a content and a period of time during which the state has been maintained.

The screen area process state information denotes frequency (switching count) of active/inactive switching operation between the window 252-2 and another window 252 in the display screen 251 of the display 25 and the state (frequency, input count) of input operation in another window 252 different from the window 252-2 displaying a content, for example, in the case where multiple windows 252 including the window 252-2 are displayed on the display screen 251.

The state of input operation in another window 252 is calculated as an input count per arbitrary unit time by acquiring inputs, by the keyboard 22 or mouse 24 and any other input device (such as touch panel (not shown)), to the window 252-1 in which a word processor is executed, for example. In addition, this screen area process state information can be employed as information indicative of a superimposition state between the window 252-2 and another window 252 (such as an area ratio between a context or a superimposed portion and a non-superimposed portion).

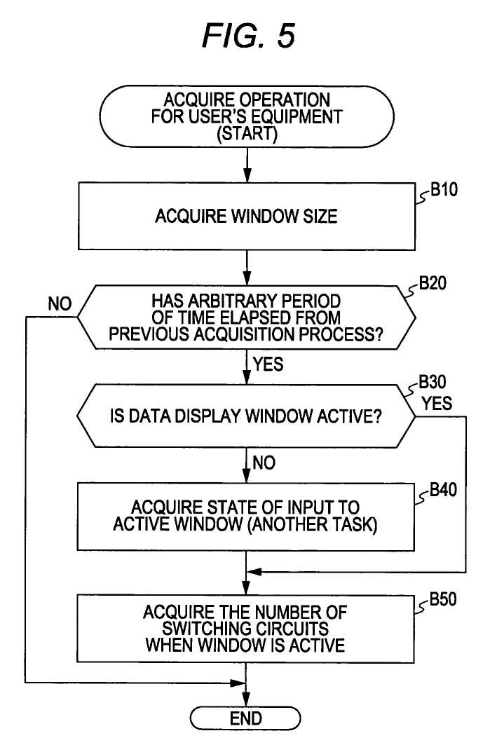

Hereinafter, a method of acquiring state information by the state information acquisition unit 102 of the information processing apparatus 100 according to an embodiment of the invention will be described with reference to the flow chart shown in FIG. 5 (steps B10 to B50).

The state information acquisition unit 102 acquires a window size of the window 252-2 or another window 252 in which a TV program is displayed or an elapsed period of time thereof in the display screen 251 of the display 25, from the display control unit 101 (step B10; state information acquisition step, content display screen area display information acquisition step). Next, the acquisition unit determines an elapsed period of time after equipment process state information has been acquired immediately before (step B20).

In the case where a predetermined period of time has elapsed after the immediately preceding acquisition process (refer to YES route in step B20), it is checked whether or not the window 252-2 in which a TV program is displayed is active (step B30). In the case where the window 252-2 is not active (refer to NO route in step B30), an input state by an input device such as the keyboard 22 or the mouse 24 in the active window 252 (a task pertinent to software other than the TV program display program executed in the window 252-2) is then acquired (step B40).

Thereafter, the state information acquisition unit 102 acquires a frequency (switching count) of a switching operation of active/inactive between the window 252-2 and another window 252 (step B50; state information acquisition step, screen area process state information acquisition step), and terminates processing.

In the case where the window 252-2 in which a TV program is displayed is active (refer to YES route in step B30), on the other hand, the current step moves to step B50.

In the case where a predetermined time has not been elapsed after the immediately preceding acquisition process in step B20 (refer to NO route in step B20), processing is terminated. This is because, in the case where the predetermined time has not been elapsed after the immediately preceding acquisition process, state information does not vary much.

The window size of the window 252-2 or another window 252 in which a TV program is displayed, its elapsed period of time, and information (state information) such as switching count of active/inactive between the window 252-2 and another window 252, which are acquired by the state information acquisition unit 102, are stored in the HDD 23 or RAM 29 or any other storage medium (not shown).

The preference evaluation value calculation unit 104 calculates a preference evaluation value pertinent to contents displayed in the window 252-2, based on the state information acquired by the state information acquisition unit 102.

The preference evaluation value is a numeric value for calculating preference data of a user (viewer) about the contents displayed in the window 252-2 displayed on the display screen 251 so as to be calculated based on the state information or equipment process state information described previously. In the information processing apparatus 100, the preference evaluation value is employed as a correction value relative to the preference reference value calculated by the preference reference value calculation unit 105.

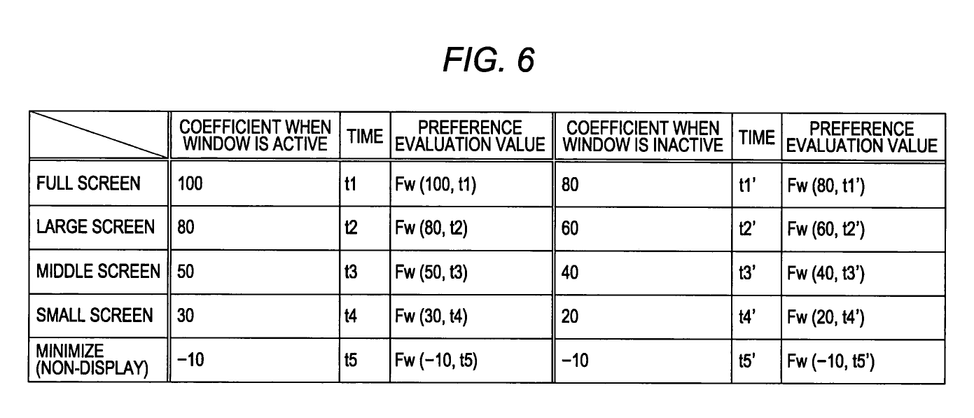

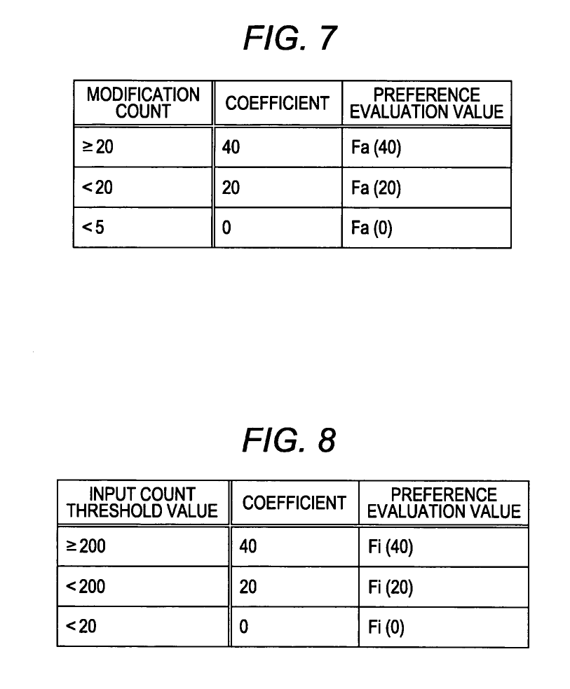

FIGS. 6 to 8 are diagrams for explaining a method of calculating a preference evaluation value by the preference evaluation position calculation unit 104 in the information processing apparatus 100 according to an embodiment of the invention. FIG. 6 is a diagram showing an example of calculating a preference evaluation value based on content display screen area display information. FIGS. 7 and 8 are diagrams each showing an example of calculation a preference evaluation value based on screen area process state information.

The example shown in FIG. 6 shows a case of calculating a preference evaluation value by employing as content display screen area display information the window size of the window 252-2 and its window state in states of active and inactive of the window 252-2.

In this example shown in FIG. 6, the size of the window 252 is classified into five types of full screen, large screen, middle screen, small screen, and non-display, and coefficients are set relative to a case in which the windows of these sizes are active and inactive.

The full screen denotes a state of a maximum size in which the window 252 has been displayed fully of the display screen 251 and denotes a state in which the window 252-2 at the time of displaying a TV program has been displayed fully of the display screen 251 with the use of a maximizing function of Microsoft Windows (registered trademark), for example. In addition, minimizing denotes a state (non-display) in which the window 252 or at least the TV program display area 262 is not displayed on the display screen 251 and denotes a state in which only Tool Bar is displayed on the display screen 251 by a minimizing function of Microsoft Windows (registered trademark), for example.

Further, large screen, middle screen, and small screen are determined depending on an actual size of the window 252 or a size ratio of the window 252 to the size of the display screen 251. The screen size is classified into any one of them, based on the size of the window 252-2 at the time of displaying a TV program. The term “time” denotes a continuation time (units: seconds, for example) of the state of the window size in the window 252-2.

For example, in the case where the window 252-2 on which a TV program is displayed is active, there is a high possibility that a user views this TV program. Further, as the window size of the window 252-2 increases, it is possible to determine that the user has more interest for the contents of the TV program (the user has higher degree of preference), and a larger coefficient is set concurrently. In other words, in the information processing apparatus 100, the window size or active state of the window 252-2 is employed to determine the user's preference.

The preference evaluation value is calculated as a function Fw that is based on a coefficient according to the window size when the window is active or inactive and its continuation time. For example, in the case where the window 252-2 has been displayed in a full screen state for 30 minutes, a coefficient 100 is selected, and the preference evaluation value calculation unit 104 calculates a preference evaluation value by a function Fw (100, 30). Hereinafter, the preference evaluation value calculated by the function Fw is indicated as a preference evaluation value Fw in some cases.

The function Fw is an arbitrary function of which an active or inactive coefficient and its continuation time are defined as variables, and is preset. The function Fw or coefficient at the time active or inactive window display can be varyingly modified and practiced.

In the present embodiment, the size of the window 252 is classified into five types of full screen, large screen, middle screen, small screen, and non-display, and coefficients are set relative to respective ones of when the windows are active and inactive in these window sizes. Without being limited thereto, however, the window size may be classified into four types or less, or alternatively, six types of more, for example, and can be variously modified and practiced without departing from the spirit of the invention.

The example shown in FIG. 7 shows a case of calculating a preference evaluation value based on a coefficient according to the count (change count) when an active window switching (changing) operation has been performed between the window 252-2 and another window 252.

In the example shown in FIG. 7, the change count is classified into three types, such as 4 or less, 5 through 19, and 20 or more, and coefficients (0, 20, 40) different from each other are set, respectively.

The preference evaluation value is calculated as a function Fa that is based on a coefficient according to the change count. For example, in the case where switching of active window from the window 252-2 to another window 252 has been performed 10 times, a coefficient 20 is selected, and the preference evaluation value is calculated by a function Fa(20). Hereinafter, the preference evaluation value calculated by the function Fa is indicated as a preference evaluation value Fa in some cases.

The function Fa is an arbitrary function of which the coefficient according to the count of active window switching (changing) operation performed between the window 252-2 and another window 252, and is preset. In addition, the function Fa or the coefficient of the change count can be varyingly modified and practiced.

In the present embodiment, the count of an active window switching (changing) operation performed therebetween is classified into 4 or less, 5 through 19, and 20 or more between the window 252-2 and another window 252, and coefficients are set relative to each of them. Without being limited thereto, however, the count of the active window switching (changing) operation performed therebetween may be classified into two types or less, or alternatively, four types or more, for example, and can be variously modified and practiced without departing from the spirit of the invention.

The example shown in FIG. 8 shows a case of calculating a preference evaluation value based on a coefficient according to the count (input count) of input operation that has been performed from an input device such as the keyboard 22 or mouse 24 in another window 252 that is different from the window 252-2. In this example, the input count is classified into three types of 19 or more, 20 through 199, and 200 or more, and coefficients (0, 20, 40 different from each other are set, respectively.

The preference evaluation value is calculated as a function F1 that is based on the coefficient according to the input count. For example, in the case where 150 input operations have been performed in another window 252 that is different from the window 252-2, a coefficient 20 is selected, and the evaluation value is calculated by a function Fi(20). Hereinafter, the preference evaluation value calculated by the function F1 is indicated as a preference evaluation value Fi in some cases.

The function F1 is as an arbitrary function of which the coefficient according to the count of input operation (such as typing or clicking) performed by the keyboard 22 or the mouse 24 is defined as a variable in another window 252 that is different from the window 252-2, and is preset. In addition, the function Fi or the coefficient of input count can be variously modified and practiced.

In the present embodiment, the count of input performed in another window 252 that is different from the window 252-2 is classified into 19 or less, 20 through 199, and 200 or more, and coefficients are set relative to respective ones of them. Without being limited thereto, however, the count of input performed in another window 252 that is different from the window 252-2 may be classified into two types or less, or alternatively, four types or more, for example, and can be variously modified and practiced without departing from the spirit of the invention.

For example, assume that when multiple windows 252 are displayed on the display screen 251, the window 252-2 in which a TV program is displayed may be hidden by another window 252 (for example, window 252-1), active window switching may be frequently performed between another window 252 and the window 252-2 or input operation by an input device such as the keyboard 22 may be frequently performed in another window 252. In such a case, it is possible to determine that the user is not watching the TV program displayed in the window 252-2 for a reason why preference is given to processing in another window 252, for example (low degree of attention).

Therefore, in the information processing apparatus 100, the active/inactive switching state of multiple windows 252 in the display screen 251 or the count of input operation in the window 252-2 or another window 252 or the like are employed to determine the user's preference.

Further, the preference evaluation value calculation unit 104 calculates a preference evaluation value pertinent to contents displayed in the window 252-2, based on the equipment process state information acquired by the equipment process state information acquisition unit 108 as well. In the information processing apparatus 100, the preference evaluation value calculated based on the equipment process state information is also employed as a correction value relative to the preference evaluation value calculated by the preference reference value calculation unit 105.

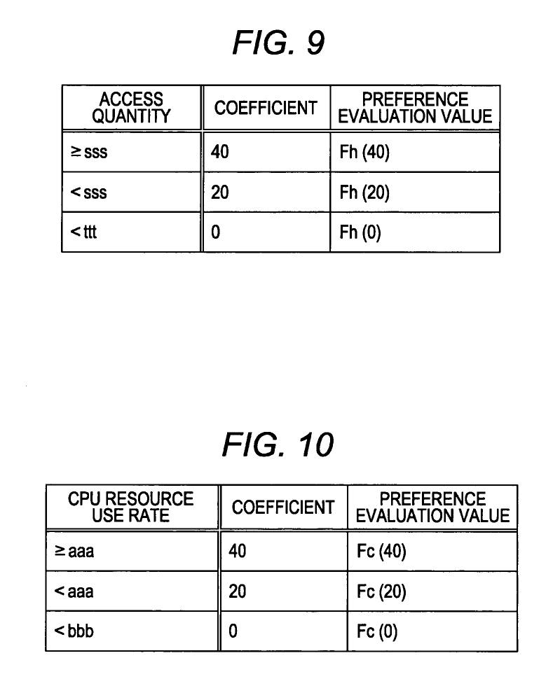

FIGS. 9 and 10 are diagrams for explaining a method of calculating a preference evaluation value by the preference evaluation value calculation unit 104 in the information processing apparatus 100 according to an embodiment of the invention. The figures each show an example of calculating a preference evaluation value based on the equipment process state information acquired by the equipment process state information acquisition unit 108.

The example shown in FIG. 9 shows a case of calculating a preference evaluation value by employing the access quantity to the HDD 23 as equipment process state information. An access quantity associated with writing into the HDD 23 is classified into three types such as ttt or less, ttt or more and sss or less, and sss or more, and coefficients (0, 20, 40) different from each other are set, respectively. Numeric values ttt and sss each represent the HDD access quantity, and an arbitrary value is preset. For example, a value represented by Write time/Write Byte is employed.

For example, at the time of displaying TV program data stored in the HDD 23 etc., in general, the access quantity according to readout from the HDD 23 comparatively increases, whereas an increase in access pertinent to writing often does not occur. Therefore, in the case where the HDD 23 write access frequently occurs, there is a high possibility that the user causes the information processing apparatus 100 to perform any process associated with a write access, and it is possible to determine that the user is not watching the TV program displayed in the window 252-2 (low degree of attention).

The preference evaluation value is calculated as a function Fh that is based on a coefficient according to the access quantity to the HDD 23. For example, in the case where the access quantity associated with writing to the HDD 23 is sss or more, a coefficient 40 is selected, and the evaluation value is calculated by a function Fh(40). Hereinafter, the preference evaluation value calculated by the function Fh is indicated as a preference evaluation value Fh in some cases.

The function Fh is an arbitrary function of which coefficients according to an access quantity with writing into the HDD 23 are defined as variables, and is preset. In addition, the function Fh and the coefficients according to the access quantity with writing into the HDD 23 can be variously modified and practiced.

In the present embodiment, the access quantity with writing into the HDD 23 is classified into three types such as ttt or less, ttt or more and sss or less, and sss or more, and coefficients are set relative to respective ones. Without being limited thereto, however, the access quantity with writing into the HDD 23 may be classified into types or less or four type or more, for example, and can be varyingly modified and practiced without departing from the spirit of the invention.

The example shown in FIG. 10 shows a case of calculating a preference evaluation value by employing as equipment process state information, a rate (use rate: in units of %) when a task pertinent to software other than a TV program display program executed in the window 252-2 uses resources of the CPU 10 (CPU resources). In this case, the use rate is classified into three types such as bbb or less, bbb or more and aaa or less, and aaa or more, and coefficients (0. 20, 40) different from each other are set, respectively.

Numeric values “aaa” and “bbb” each represent a use rate of the CPU resources, and an arbitrary value is preset.

In the present embodiment, the use rate of the CPU resources of the task other than the TV program display program executed in the window 252-02 is obtained by averaging it by an arbitrary unit of time. Based on this average value, a preference evaluation value is calculated.

For example, in the information processing apparatus 100, a load of the CPU 10 according to a process for displaying TV program data may be comparatively low. In this case, when the task according to a program that is irrelative to the TV program display program executed in the window 252-2 frequently uses resources of the CPU 10 as a result of investigating the task that is executed (operates) in the CPU 10 at the same time of displaying the TV program in the window 252-2, it is found that the information processing apparatus 100 is employed for usage other than displaying the TV program. In other words, it is possible to determine a high possibility that the user is not watching the TV program displayed in the window 252-2 (low degree of attention).

The preference evaluation value is calculated as a function Fc that is based on a coefficient according to a use rate of CPU resources. For example, in the case where the use rate of CPU resources of software other than the TV program display program that is executed in the window 252-2, a coefficient 40 is selected, and the evaluation value is calculated by a function Fc(40). Hereinafter, the preference evaluation value calculated by the function Fc is indicated as a preference evaluation value Fc in some cases.

The function Fc is an arbitrary function of which coefficients according to the use rate of CPU resources of the task pertinent to software other than the TV program display program that is executed in the window 252-2 are variables, and is preset. In addition, the function Fc or the coefficients according to the use rate of CPU resources can be varyingly modified and practiced.

In the present embodiment, the use rate of CPU resources of the task pertinent to software other than the TV program display program that is executed in the window 252-2 is classified into three types such as bbb or less, bbb or more and aaa or less, and aaa or more, and coefficients are set relative to respective ones. Without being limited thereto, however, the use rate of CPU resources of the task pertinent to software other than the TV program display program that is executed in the window 252-2 may be classified into two types or less, or alternatively, four types or more, for example, and can be varyingly modified and practiced without departing from the spirit of the invention.

The preference data generation unit 107 serves to generate preference data pertinent to a content based on the preference evaluation value that is calculated by a preference evaluation value calculation unit 104. In the information processing apparatus 100 of the present embodiment, the calculation unit serves to generate preference data, based on the preference reference value calculated by the preference reference value calculation unit 105 and preference evaluation values (Fw, Fa, Fi, Fh, Fc) that are calculated by a preference evaluation value calculation unit 104.

Specifically, the preference data generation unit 107 serves to generate a preference value (preference data) by applying, as a correction value, the preference evaluation value calculated by the preference evaluation value calculation unit 104 relative to the preference reference value calculated by the preference reference value calculation unit 105. For example, the data generation unit serves to calculate a correction value by applying (multiplying) a predetermined coefficient K relative to each of the preference evaluation values shown in FIGS. 6 to 10, and then, adding these correction values to the preference reference value, thereby calculating preference values.

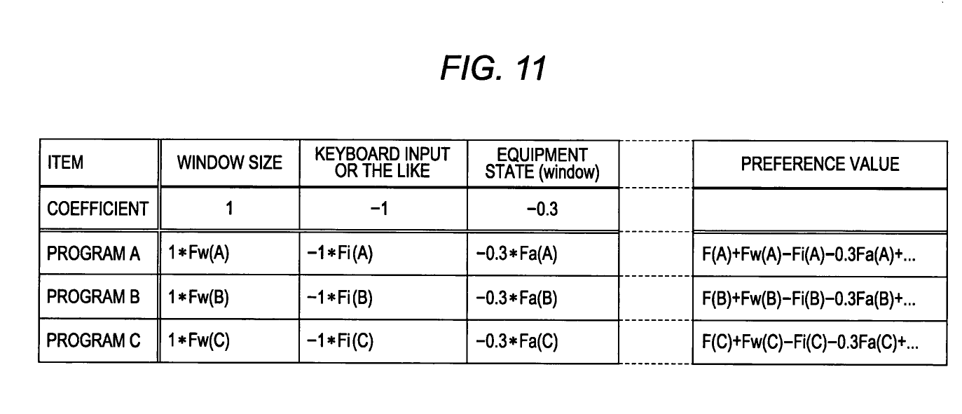

FIG. 11 is a diagram for explaining a method of generating a preference value (preference data) in the information processing apparatus 100 according to an embodiment of the invention.

FIG. 11 shows a method of calculating a preference value relative to each of programs (TV programs) A, B, C, wherein a coefficient K=1.0 is set at a function Fw that is based on the window size of the window 252-2 and a time during which the window state has been maintained; a coefficient K=(−1, 0) is set at a frequency Fi that is based on the count of input to another window 252 that is different from the window 252-2, expressed by an item “input to keyboard or the like”; and a coefficient K=(−0.3) is set at a function Fa that is based on the change count of active window between the window 252-2 and another window 252, as expressed by an item “equipment state”, respectively.

A preference value is calculated by adding at least any of the correction values calculated by multiplying a predetermined coefficient K for the preference evaluation values Fw, Fa, Fi, Fh, and Fc described above, respectively. In the example shown in FIG. 8, the correction values calculated based on at least the preference evaluation values Fw, Fi, Fa are added to the preference reference value F, thereby performing correction and calculating preference values.

In FIG. 8, for the sake of convenience, the function F indicative of a preference reference value is followed by any one of the parenthesized uppercase letters A, B, and C, thereby indicating which of the programs A, B, and C is relative to the preference reference value. Similarly, in FIG. 8, the functions Fw, Fi, and Fa indicative of preference evaluation values are followed by any one of the parenthesized uppercase letters A, B, and C, thereby indicating which of the programs A, B, and C is relative to the preference evaluation value. In FIG. 8, for the sake of convenience, the preference evaluation values Fc, Fh are not displayed.

For example, in FIG. 11, a preference evaluation value Fw(A) is calculated by a function Fw that is based on a coefficient according to the window size when the window 252-2 displaying a program A is active or inactive and its continuation time.

In the case where the preference data generation unit 107, as shown in FIG. 11, calculates the preference value of the program A, for example, the preference value is calculated by adding 1*Fw(A) obtained by adding to the preference reference value F(A), 1*Fw(A) obtained by multiplying a coefficient K=1 for the preference evaluation value Fw(A); (−1)1*Fw(A) obtained by multiplying a coefficient K=(=1) for the preference evaluation value Fi(A); and (−3)*Fa obtained by multiplying a coefficient K=(−0.3) for the preference evaluation value Fa(A) (refer to FIG. 1).

Preference value=F(A)+1*Fw(A)+(−1)*Fi(A)+(−0.3)*Fa(A)

Then, the preference data generation unit 107 serves to save/store the generated preference value (preference data) in the HDD 23 etc. after associated with information for specifying the TV program.

When the preference data generation unit 107 calculates the preference value on the TV program displayed in the TV program display area 262 of the window 252-2, the preference value pertinent to the TV program may be saved in the HDD 23 etc. In such a case, the preference value saved in the HDD 23 is acquired so as to reflect the newly calculated preference value on the preference value saved in advance (archived preference value).

For example, the preference data generation unit 107 can employ as a preference value an average value between the newly calculated preference value and the archived preference value.

The preference data generation unit 107 may employ the archived preference value in place of the preference reference value calculated by the preference reference value calculation unit 105 to add to the archived preference value a variety of preference evaluation values obtained by multiplying coefficients, respectively, as described above, thereby generating preference data. The preference data generation unit 107 may also overwrite the archived preference value by the newly calculated preference value without reflecting the newly calculated preference value on the archived preference value. In other words, after deleting the archived preference value, the newly calculated preference value may be employed in place of the thus detected archived preference value.

The image recording unit (recording unit) 109 serves to record as an image a TV program acquired by a content acquisition unit 26. For example, assume that in the TV program display area 262 of the display screen 251, a user selects (depresses) an image recording button 261m or an image recording instruction is assigned by an image recording reservation function. In this event, the target TV program is image-recorded (recorded) in a storage medium such as the HDD 23. In addition, when the image recording unit 109 records a TV program, EPG data associated with the TV program or the preference value generated by the preference data generation unit 107 are also recorded after associated with the TV program.

Further, the image recording unit 109 has a function of, based on a preset user's preference, selecting a TV program adaptive to that preference, in accordance with content information acquired by the content information acquisition unit 27, and automatically recording an image. Data on a TV program to be recorded as an image (data on contents) are recorded in a storage unit such as the HDD 23, or a recording medium such as a DVD (not shown).

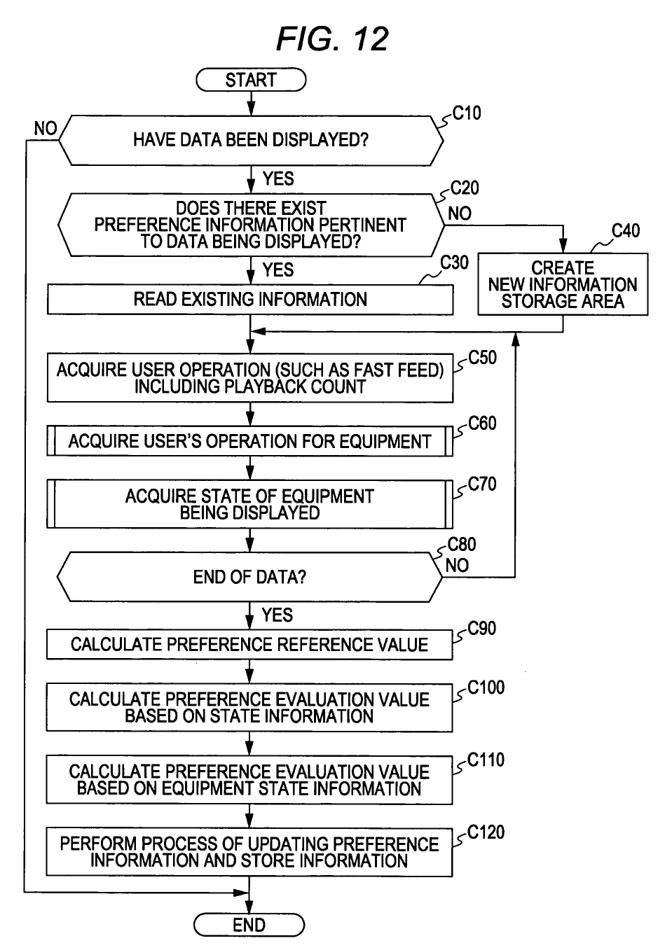

The preference analysis method at the time of displaying a TV program in the information processing apparatus 100 according to an embodiment, configured as described above, will be described in accordance with the flow chart shown in FIG. 12 (steps C10 to C120).

In the information processing apparatus 100, the content acquisition unit 26 receives data on a TV program, and the content playback unit 106 plays back the data of the received TV program. Then, the display control unit 106 is caused to display the thus played back TV program in the TV program display area 262 of the window 252-2. During this period, the content playback unit 106 and the display control unit 101 acquire content display setting information from the HDD 23, and displays a TV program based on the content display setting information.

Here, the CPU 10 checks whether or not the TV program is displayed on the display screen 251 (step C10). In the case where the program is not display (refer to NO route in step C10), the CPU terminates processing. On the other hand, in the case where the TV program is displayed on the display screen 251 (refer to YES route in step C10), a preference data generation unit 107 then checks whether or not a preference value (preference information) pertinent to a TV program displayed in the window 252-2 exists in a storage medium such as the HDD 23.

In the case where the preference value pertinent to the TV program already exists in a storage medium such as the HDD 23 (refer to YES route in step S20), the preference data generation unit 107 reads the preference value (step C30).

While the TV program is displayed in the window 252-2, operation history information 10 acquires as an operation history, operation information such as fast feed or volume control that the user has performed with the use of an input device such as the mouse 24 in the window 252-2 (step S50). Then, the state information acquisition unit 102 acquires state information pertinent to the window 252 displayed on the display screen 251 of the display 25 (step C60; state information acquisition step). The method of acquiring state information by the state information acquisition unit 102 has been described previously with reference to FIG. 5.

On the other hand, in the case where the preference value pertinent to the TV program displayed in the window 252-2 does not exists in a storage medium such as the HDD 23 (refer to NO route in step S20), the preference data generation unit 107 allocated in a storage medium such as the HDD 23 an area for storing a preference value to be calculated from now (step C40). Then, the current step moves to step A50.

Further, while the TV program is displayed in the window 252-2, the equipment process state information acquisition unit 108 acquires equipment process state information (step C70; equipment process state information acquisition step). The method of acquiring equipment process state information by the equipment process state information acquisition unit 108 has been described previously with reference to FIG. 4.

Then, the CPU 10 checks whether or not the TV program has terminated, in other words, displaying data on contents has terminated (step C80). In the case where the program has not terminated (refer to NO route in step C80), the current step reverts to step C50. On the other hand, in the case where the TV program has terminated (refer to YES route in step C80), the preference reference value calculation unit 105 calculates a preference reference value, based on the operation history acquired/generated by the operation history generation unit 110 while the TV program is displayed.

The preference evaluation value production unit 104 calculates a preference evaluation value based on the state information acquired by the state information acquisition unit 102 (step C100; preference evaluation value calculation step), and calculates a preference evaluation value based on the equipment process state information acquired by the equipment process state information acquisition unit 108 (step C10; preference evaluation value calculation step).

Then, the preference data generation unit 107 generates a preference value by applying as a correction value the preference evaluation value calculated by the preference evaluation value calculation unit 104, relative to the preference reference value that is calculated by the preference reference value calculation unit 105. Subsequently, the preference data generation unit 107 saves the thus generated preference value in a storage medium such as the HDD 23 after associated with the TV program (step C120; preference data generation step. In the case where the preference value pertinent to the TV program has already existed in a storage medium such as the HDD 23 in step C20, the preference data generation unit 107 updates the preference value stored in the HDD 23 in advance by a newly generated preference value, and then, terminates processing.

In this way, according to the information processing apparatus of an embodiment of the invention, the state information acquisition unit 102 acquires state information pertinent to multiple windows 252 displayed on the display screen 251 of the display 25; the preference evaluation value calculation unit 104 calculates a preference evaluation value pertinent to the contents based on this state information; and the preference data generation unit 107 generates preference data based on the preference evaluation value, thereby making it possible to generate preference data reflecting a viewer's preference.

In addition, the preference reference value calculation unit 105 calculates a preference reference value pertinent to a content based on an operation history according to display of contents in the information processing apparatus 100; and the preference data generation unit 107 generates preference data, based on the thus calculated preference reference value and preference evaluation value, thereby making it possible to generate more precise preference data reflecting a viewer's preference.

Further, the equipment process state information acquisition unit 108 acquires equipment process state information pertinent to processes that are executed in the information processing apparatus 100, and then, the preference evaluation value calculation unit 104 calculates a preference evaluation value, based on this equipment process state information. This makes it possible to easily and reliably calculate the preference evaluation value and also to generate more precise preference data reflecting a viewer's preference.

State information can be easily acquired by content display screen area display information pertinent to a display state of the window 252-2 in the display screen 251 of the display 25 or screen area process state information indicative of a processing state pertinent to the multiple windows 252 in the information processing apparatus 100.

The information processing apparatus 100 has a notification function of, if a predetermined event has been detected in a TV program displayed in the window 252-2, notifying the user of the fact.

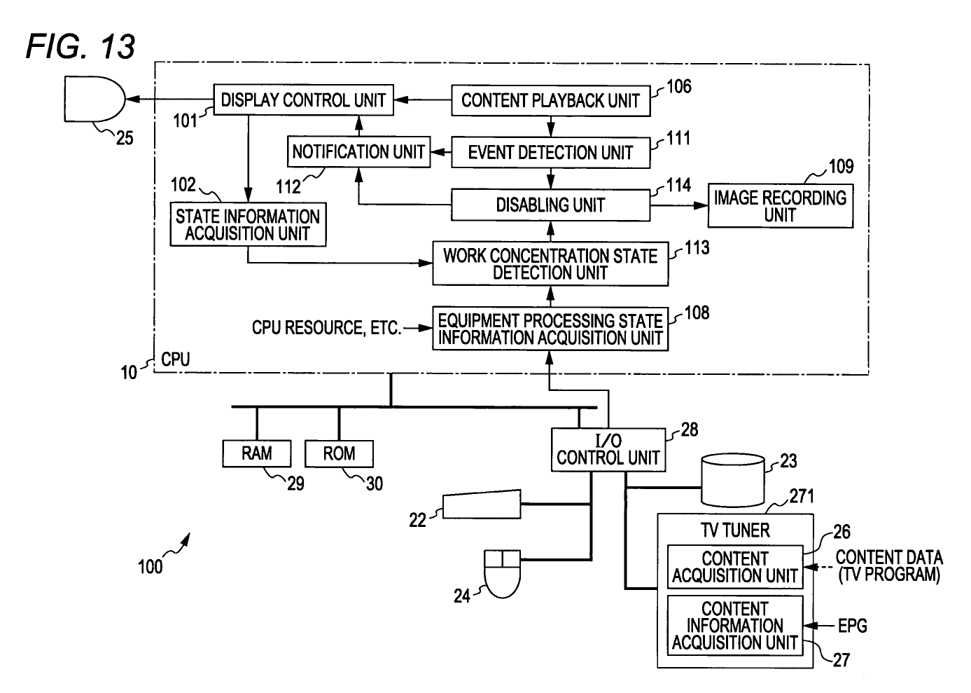

FIG. 13 is a diagram showing a functional configuration for achieving the notification function in the information processing apparatus 100 according to an embodiment of the invention.

The CPU 10 functions as the display control unit 101, the state information acquisition unit 102, an event detection unit 111, a notification unit 112, a work concentration state detection unit 113, a deterring unit 114, and the image recording unit 109, as shown in FIG. 13, in order to achieve the notification function.

In FIG. 13, for the sake of convenience, the preference evaluation value calculation unit 104, the preference reference value calculation unit 105, the preference data generation unit 107, and the operation history generation unit 110 are not shown. In the figure, like or substantially like constituent elements are designated by like or substantially like reference numerals. A detailed description is omitted here.

The event detection unit 111 serves to detect a predetermined event pertinent to a TV program that is displayed in the window 252-2. This event is preset as an event condition by a user or the like, and the event detection unit serves to determine that an event has been detected when an event meeting this event condition has been detected in the TV program displayed in the window 252-2.

This event may be start of a TV program that user has desired to view (has reserved) or a TV program of a genre of which the degree of the user's preference is high (such as drama, news, or weather forecast) or performing or appearing of television personality that the user likes in a TV program, or change of contents such as termination of commercial message having flowed in the middle of a program, and can be variously modified and practiced within departing from the spirit of the invention.

Then, the event detection unit 111 serves to detect these events, based on the information on contents played back by the content playback unit 106, for example, or content information acquired by the content information acquisition unit 27, and these detection methods can be variously modified with the use of a known method.

The notification unit 112 serves to, if a predetermined event has been detected by the event detection unit 111, notify the use of the information processing apparatus 100 of the fact. For example, in the case where the event detection unit 111 detects that a commercial message has terminated in the TV program displayed in the window 252-2, the window 252-2 is largely displayed (expansion display, full-size display) on the display screen 251, thereby performing enhancement display, or alternatively, a message indicating that an event has detected is displayed on the display screen 251.

The notification by the notification unit 112 can be variously modified and practiced without being limited to the method described above. For example, assume that at the notification unit 112, in a state in which the window 252-2 is inactive in the display screen 151, the event detection unit 111 has detected a predetermined event. In this case, the window 252-2 may be displayed on the most frontal face in the display screen 251 while the window is made active.

After multiple windows 252 have been displayed on the display screen 251 of the display 25, the user may be doing a work by a word processor in the window 252-1 that is one of the windows 252. In this event, if a predetermined event has been detected by the event detection unit 111, the notification unit 112 displays the window 252-2 in an expanded manner so as to overlap the window 252-1, thereby notifying of event detection in the window 252-2.

In addition, the notification unit 112 may perform notification by a variety of methods such as varying the volume according to the window 252-2 so as to increase or performing voice notification that an event has occurred. A variety of known methods such as a method disclosed in Japanese Patent Application Laid-open No. 2004-133733 can be employed, for example.

The notification method by the notification unit 112 can be preset, and further, this setting can be provided by contents (TV program in the present embodiment), and notification setting information is stored in advance in a storage medium such as the HDD 23 after associated with information for specifying the contents (such as program name).

Then, the notification unit 112 checks the presence or absence of the notification setting information. In the case where the notification setting information exists, the notification unit 112 notifies of event detection in accordance with the notification setting information.

In the HDD 23, the default settings provided when notification setting information has been arbitrarily preset are also stored, and the notification unit 112 serves to acquire and apply notification setting information from the default settings with respect to contents of which no notification setting information is set.

The work concentration state detection unit 113 serves to detect a user's work concentration state in the information processing apparatus 100. The detection unit also serves to detect that the user concentrates on processing executed in the window 252 other than the window 252-2 in which a TV program is displayed (hereinafter, occasionally referred to as work concentration state) so as to notify the deterring unit 114 of the fact.

For example, when the work concentration state detection unit 113 has detected that the user concentrates on processing executed in the window 252-1 of the multiple windows 252 displayed on the display screen 251 of the display 25, the detection unit sets a flag indicative of the fact in a specific storage area in a storage medium such as the RAM 29 or HDD 23, thereby notifying the deterring unit 114 of the fact.

The work concentration state detection unit 113 serves to detect a work concentration state, based on state information acquired by the state information acquisition unit 102, for example.

For example, the work concentration state detection unit 113 serves to detect a work concentration state, based on a state of the window 252-2 displaying contents (such as window size, active/inactive state) and a time maintaining the state; a frequency (switching count) of active/inactive switching operation between the window 252-2 and another window 252 in the display screen 251 of the display 25; a state (frequency, input count) of input operation in another window 252 that is different from the window 252-2 displaying contents; information indicative of a superimposition state relative to another window 252 (such as context or area ratio of a superimposed portion and a non-superimposed portion). It is determined that a work concentration state is established in any one of a case where a continuation time of an inactive state of the window 252-2 displaying contents is long (a case where the continuation time is longer than predetermined threshold value), a case where the frequency of active/inactive switching operation between the window 252-2 and another window 252 is high (a case where the frequency is higher than preset threshold value), a case where the input count in another window 252 that is different from the window 252-2 displaying contents is large (a case where the input count is more than the preset threshold value), and a case where another window 252 is displayed more frontal than the window 252-2.

In addition, the work concentration state detection unit 113 serves to detect a work concentration state, based on the equipment process state information acquired by the equipment process state information acquisition unit 108.

For example, the work concentration state detection unit 113 serves to detect that a work concentration state is established in the case where a use rate of CPU resources or access quantity to the HDD 23 (Write time/Write Byte) is high, relative to a task pertinent to software other than a TV program display program executed in the window 252-2 in a use level of the CPU resources (in the case where the use rate and access quantity is higher than the preset threshold value).

With respect to the state of input operation in another window 252, the input to the window 252-1 in which a word processor is executed, is acquired by the keyboard 22, the mouse 24 or any other input device (such as touch panel (not shown)), and the input count per an arbitrary unit time is calculated. The screen area process state information can be employed as information indicative of a superimposition state relative to an arbitrary other window 252 (such as context or area ratio of a superimposed portion and a non-superimposed portion).

The method of notifying the deterring unit 114 of the work concentration state by the work concentration state detection unit 113 is not limited to the method using a flag described above, and can be varyingly modified and practiced without departing from the spirit of the invention.

The deterring unit 114 serves to deter notification by the notification unit 112 if the work concentration state detection unit 108 has detected the user work concentration state. For example, the deterring unit serves to deter notification that is performed by the notification unit 112 displaying the display screen 251 to be large, displaying the window 252-2 to be small or minimizing the window 252-2, or alternatively, deters (disables) notification performed by displaying a message indicating the fact that an event has been detected.

Specifically, the deterring unit 114 changes (corrects) notification setting information saved in an input device such as the HDD 23, and changes the notification setting information to such setting disabling change of the window size of the window 252-2 in the display screen 251 or such setting (window size) reducing and minimizing the window size and enabling establishment of a non-display state and such setting disabling display of a message indicating that an event has been detected.

Moreover, the deterring unit 114 supplies an image recording instruction of a TV program displayed in the window 252-2 relative to the image recording unit 109 so that the image recording unit 109 may record the TV program as an image in the HDD 23 in accordance with an image recording instruction of the deterring unit 114.

In the case where the deterring unit 114 instructs the image recording unit 109 to instruct image recording of the TV program, the user may disable watching the TV program, for example, by minimizing the window 252-2 in the display screen 251.

Instead of changing (correcting) the notification setting information stored in the HDD 23, as described above, the deterring unit 114 may perform instruction/control so as to deter notification by displaying on the largely display screen 251 the window 252-2 caused by the notification unit 112 relative to the notification unit or the display control unit 101; may be perform instruction/control so as to display the winder 252-2 to be small or so as to minimize the window 252-2; may perform instruction/control so as to deter (disable) notification caused by displaying a message indicating that an event has been detected; or alternatively, may perform an instruction so as to establish the window 252-2 in a non-display state relative to the display control unit 101 at the time of performing an image recording instruction of the TV program displayed in the window 252-2 relative to the image recording unit 109.

Settings of notification setting information by the deterring unit 114 are properly changed in accordance with the notification method by the notification unit 112.

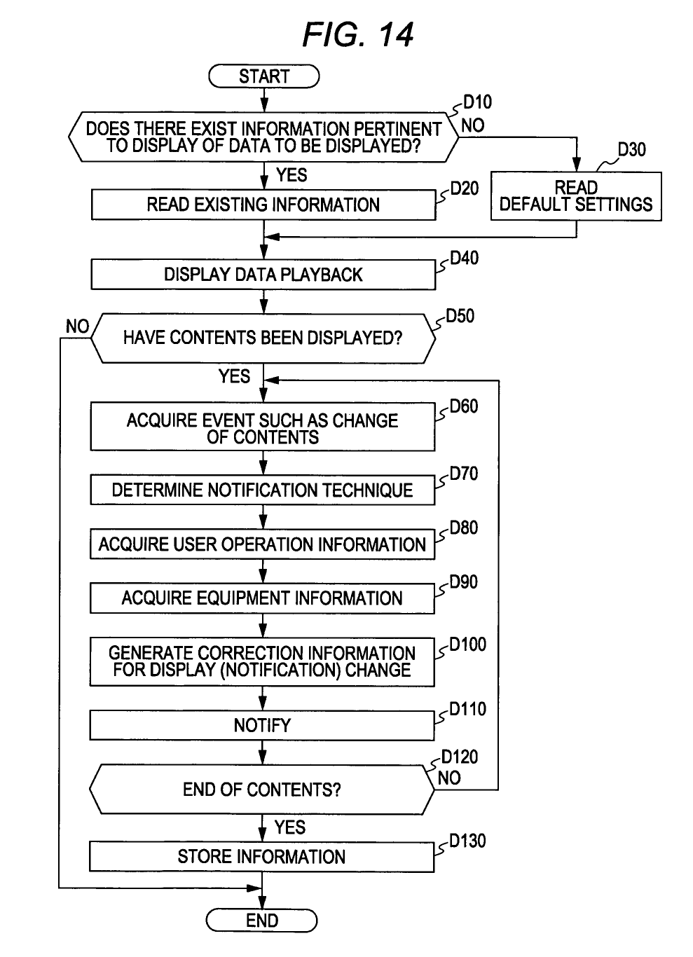

The method of notifying of event detection at the time of displaying contents in the information processing apparatus 100 according to an embodiment of the invention, configured as described above, will be described in accordance with the flow chart (steps D10 to D130) shown in FIG. 14.

For example, in the information processing apparatus 100, when the content acquisition unit 26 has received data on a TV program, and then, the thus received data on the TV program is displayed, the content playback unit 106 and the display control unit 191 check whether or not content display setting information or notification setting information pertinent to a TV program displayed in the window 252-2 exists in the HDD 23 (step D10). In the case where the information exists (refer to YES route in step D10), these content display setting information and notification setting information are read (step D20). On the other hand, in the case where the content display setting information on the TV program does not exist in the HDD 23 (refer to NO route in step D10), default settings of the content display setting information are read from the HDD 23 (step D30).

The content playback unit 106 and the display control unit 101 display the TV program on the window 252-2 displayed on the display 25, based on the content display setting information acquired from the HDD 23 (step D40).

The event detection unit 111 checks whether or not a TV program is displayed in the window 252-2 (step D50) and terminates processing in the case where the TV program is not displayed (refer to NO route in step D50). The state in which the TV program is displayed in the window 252-2 includes a state in which, although another window 252 in an active state is hidden, a playback process is executed in the background.

In the case where the TV program is displayed in the window 252-2 (refer to YES route in step D50), if the event detection unit 111 detects a predetermined event pertinent to the TV program displayed in the window 252-2 (step D60; event detection step), the notification unit 112 determines a notification method at the time of event detection, based on notification setting information (step D70).

While the TV program is displayed in the window 252-2, the equipment process state information acquisition unit 108 acquires operation information such as fast feed or volume control made with the use of an input device such as the mouse 24 in the window 252-2 (step D80), and the state information acquisition unit 102 acquires state information pertinent to the window 252 displayed on the display screen 251 of the display 25. The method of acquiring state information by the state information acquisition unit 102 has been described previously with reference to FIG. 5.

In addition, the state information acquisition unit 102 acquires state information pertinent to the window 252 displayed on the display screen 251 of the display 25, and the equipment process state information acquisition unit 108 acquires equipment process state information (step D90). The method of acquiring state information by the equipment process state information acquisition unit 108 has been described previously with reference to FIG. 4.

The work concentration state detection unit 113 detects the user's work concentration state in the information processing apparatus 100 and notifies the deterring unit 114 of the fact, based on the state information acquired from the state information acquisition 102 or the equipment process state information acquired from the equipment process state information acquisition unit 108. If the user's work concentration state is notified by the work concentration state detection unit 113, the deterring unit 114 changes (corrects) notification setting information; changes notification setting information to such setting disabling change of the window size of the window 252-2 in the display screen 251 or such setting (window size) enabling reduction of the window size, minimization, or establishment of the non-display state; or changes such setting disabling display of a message indicating that an event has been detected (step D100; deterring state).

If the event detection unit 111 detects the occurrence of an event is detected in a TV program displayed in the window 252-2, the notification unit 112 performs notification, based on notification setting information (step D110; notification step).

In other words, when in step D100, correction/change is made such that notification is deterred by the deterring unit 114, notification is made such that the user's work is not interrupted, or alternatively, a TV program is image-recorded by the image recording unit 109 in the background (recording step).

The event detection unit 111 checks whether or not a TV program (TV program data) terminates (step D120), and then, reverts to step D60 in the case where the TV program does not terminate (refer to NO route in step D120). On the other hand, in the case where the TV program terminates (refer to YES route in step D120), changed notification setting information is saved (step D130), and then, processing is terminated.

In this way, according to the information processing apparatus 100 of an embodiment of the invention, the following advantage can be obtained. In the case where the work concentration state detection unit 113 has detected the user's work concentration state, the notification unit 112 deters notification relative to the user, whereby workability can be improved without interrupting the work on which the user concentrates.

Assume that, in the information processing apparatus 100, “trial viewing while doing anything else” is performed such that the TV program displayed in the window 252-2 is viewed in a trial manner while another work is performed in the window 252-1 as well. Even in this event, if the user does not concentrate on the work in the window 252-1, notification is performed by the notification unit 112 when a predetermined event has occurred in media such as a TV program. On the other hand, if the user concentrates on the work in the window 252-1, notification is not made by the notification unit 112 even if a predetermined event has occurred in media such as a TV program, so that the user's work is not interrupted. In other words, when a predetermined event has occurred in media such as TV program, a minute response to the user's work concentration state can be made.

Further, the state information acquisition unit 102 detects the work concentration state, based on the screen area process state information indicative of the processing state pertinent to multiple windows 252 in the information processing apparatus 100, thereby making it possible to easily detect the work concentration state suitable for an actual work state in the information processing apparatus 100 and to enhance convenience.

Further, the equipment process state information acquisition unit 108 also detects the work concentration state, based on the equipment process state information pertinent to the process executed in the information processing apparatus 100. This makes it possible to easily detect the work concentration state suitable for an actual work state in the information processing apparatus 100, thereby enhancing convenience.

In the case where the notification unit 112 performs notification by increasing the size of the window 252-2 in the display 25, the deterring unit 114 deters the size of this window 252-2 so as not to increase it or deters the size of the window 252-2 so as to reduce it, whereby workability can be improved, without interrupting the work on which the user concentrates by the expanded window 252-2.

Further, workability can be improved, without interrupting the work on which the user concentrates by a voice, by deterring the volume of voice together with display of a TV program.

In addition, the deterring unit 114 makes the window 252-2 non-display and the image recording unit 109 records the TV program displayed in this window 252-2, whereby workability can be improved without interrupting the work on which the user concentrates and the contents recorded later can be displayed. In this manner, the user never misses a TV program, enhancing convenience.

Programs (preference data generation program, TV program display program, playback program) are provided for achieving functions of the display control unit 101, the state information acquisition 102, the preference evaluation value calculation unit 104, the equipment process state information acquisition unit 108, the preference reference value calculation unit 105, the preference data generation unit 107, the content playback unit 106, the image recording unit 110, the event detection unit 111, the notification unit 112, the work concentration state detection unit 113, and the deterring unit 114 described above, in a mode recorded in computer-readable recording media such as flexible disk, CD (such as CD-ROM, CD-R, CD-RW), DVD (DVD-ROM, DVD-RAM, DVD-R, DVD+R, DVD-RW, DVD+RW), magnetic disk, optical disk, magneto-optical disk. Then, a computer is used to read a program from that recording medium, transfer the program to an internal storage unit or an external storage unit, and store it. In addition, the program is recorded in a storage unit (recording medium) such as magnetic disk, optical disk, or magneto-optical disk so that it may be provided from the storage unit to the computer via a communication path.

At the time of achieving functions of the display control unit 101, what are executed by the computer's microprocessors (CPU 10 in the present embodiment) are the state information acquisition unit 102, the preference evaluation value calculation unit 104, the equipment process state information acquisition unit 108, the preference reference value calculation unit 105, the preference data generation unit 107, the content playback unit 106, the image recording unit 110, the event detection unit 111, the notification unit 112, the work concentration state detection unit 113, and the deterring unit 114, and programs stored in the internal storage unit (RAM 29 or ROM 30) in the present embodiment). At this time, the programs recorded in a recording medium may be executed after they have been read by the computer.

In the present embodiment, a computer serves as a concept inclusive of hardware and an operating system, and denotes hardware that operates under the control of the operating system. In the case where the operating system is not required and hardware is operated merely by an application program, the hardware per se is equipment to a computer. The hardware is provided with at least microprocessors such as CPU and means for reading a computer program recorded in a recording medium. In the present embodiment, the information processing apparatus 100 functions as a computer.

Further, the recording media in the present embodiment can be utilized as a variety of computer-readable media such as IC card, ROM cartridge, magnetic tape, punch card, computer internal storage unit (memory such as RAM or ROM), external storage unit, or printed matter printed with codes such as barcodes, in addition to the flexible disk, CD, DVD, magnetic disk, optical disk, and magneto-optical disk described above.

The invention is not limited to the embodiments mentioned above, and can be varyingly modified and practiced without departing from the spirit of the invention.

For example, in the embodiments mentioned above, the content acquisition unit 26 is configured as a receiver unit capable of receiving the contents broadcasted via electric discharge radio waves via equipment such as antenna. Without being limited thereto, however, the acquisition unit may be a reader unit (such as DVD reader) for reading out contents recorded in a variety of media such as network equipment (such as LAN card) or DVD that is capable of receiving contents to be distributed via the Internet, and can be variously modified and practiced without departing from the spirit of the invention.

Also, in the embodiments mentioned above, the content information acquisition unit 27, like the content acquisition unit 26, is configured as a receiver unit capable of receiving EPG to be broadcasted via broadcasting radio waves via equipment such as antenna. Without being limited thereto, however, the acquisition unit may be network equipment capable of receiving the content information (such as ADAMS-EPG+, iEPG) to be distributed via the Internet, for example, and can be variously modified and practiced without departing from the spirit of the invention.

In addition, in the embodiments mentioned above, a description has been given with respect to the example in which contents are a TV program received by the TV tuner 271. Without being limited thereto, however, contents may be a variety of data broadcasted/distributed via the Internet, for example, or may be an image such as motion image provided by a variety of media such as DVD, and can be varyingly modified and practiced without departing from the spirit of the invention.

The content playback unit 106 may serve as a program for playing back a motion image or may be a program for media playback in accordance with the information on these contents, and can be varyingly modified and practiced without departing from the spirit of the invention.

As long as the embodiments of the invention are disclosed, the invention can be implemented/manufactured by one skilled in the art.

Although a few preferred embodiments have been shown and described, it would be appreciated by those skilled in the art that changes may be made in these embodiments without departing from the principles and spirit of the invention, the scope of which is defined in the claims and their equivalents.

What is claimed is:

1. A preference data generation device for generating preference data on a viewer pertinent to content displayed in a content display screen area that is one screen area of a plurality of screen areas displayed on a display unit in an information processing apparatus including the display unit, the device comprising:
a state information acquisition unit that acquires state information pertinent to the plurality of screen areas that are displayed on the display unit;
a preference evaluation value calculation unit that calculates a preference evaluation value pertinent to the content, based on the state information acquired by the state information acquisition unit; and
a preference data generation unit that generates preference data pertinent to the content, based on the preference evaluation value calculated by the preference evaluation value calculation unit.

2. The preference data generation device according to claim 1, further comprising:
a preference reference value calculation unit that calculates a preference reference value pertinent to the content, based on an operation history according to display of the content in the information processing apparatus,
wherein the preference data generation unit generates the preference data, based on the preference reference value calculated by the preference reference value calculation unit and the preference evaluation value calculated by the preference evaluation value calculation unit.

3. The preference data generation device according to claim 1, further comprising:
an equipment process state information acquisition unit that acquires equipment process state information pertinent to a process that is executed in the information processing apparatus,
wherein the preference evaluation value calculation unit calculates the preference evaluation value pertinent to the content, based on the equipment process state information acquired by the equipment process state information acquisition unit.

4. The preference data generation device according to claim 1, wherein the state information is content display screen area display information pertinent to a display state of the content display screen area.

5. The preference data generation device according to claim 1, wherein the state information is screen area process state information that is indicative of a process state pertinent to the plurality of screen areas in the information processing apparatus.

6. A content display device, comprising:
a display unit capable of displaying a plurality of screen areas;
a display control unit capable of displaying a content in a content display screen area that serves as one screen area of the plurality of screen areas;
a state information acquisition unit that acquires state information pertinent to the plurality of screen areas displayed on the display unit;
a preference evaluation value calculation unit that calculates a preference evaluation value pertinent to the content, based on the state information acquired by the state information acquisition unit; and
a preference data generation unit that generates preference data pertinent to the content, based on the preference evaluation value calculated by the preference evaluation value calculation unit.

7. The content display device according to claim 6, further comprising:
a preference reference value calculation unit that calculates a preference reference value pertinent to the content, based on an operation history according to display of the content in the content display device,
wherein the preference data generation unit generates the preference data, based on the preference reference value calculated by the preference reference value calculation unit and the preference evaluation value calculated by the preference evaluation value calculation unit.

8. The content display device according to claim 6, further comprising:
an equipment process state information acquisition unit that acquires equipment process state information pertinent to a process that is executed in the information processing system,
wherein the preference evaluation value calculation unit calculates the preference evaluation value pertinent to the content, based on the equipment process state information acquired by the equipment process state information acquisition unit.

9. The content display device according to claim 6, wherein the state information is content display screen area display information pertinent to a display state of the content display screen area in the display unit.

10. The content display device according to claim 6, wherein the state information is screen area process state information indicative of a process state pertinent to the plurality of screen areas in the content display device.

11. A preference data generation method for generating preference data on a viewer pertinent to content displayed in a content display screen area that is one screen area of a plurality of screen areas displayed on a display unit in an information processing apparatus including the display unit, the method comprising:
acquiring state information pertinent to the plurality of screen areas displayed on the display unit;
calculating a preference evaluation value pertinent to the content, based on the state information acquired; and
generating preference data pertinent to the content, based on the preference evaluation value calculated.

12. The preference data generation method according to claim 11, further comprising:
calculating a preference reference value pertinent to the content, based on an operation history according to display of the content in the information processing apparatus,
wherein the generating generates the preference data, based on the preference reference value calculated and the preference evaluation value calculated.

13. The preference data generation method according to claim 11, further comprising:
acquiring equipment process state information pertinent to a process that is executed in the information processing apparatus,
wherein the calculating calculates the preference evaluation value pertinent to the content, based on the equipment process state information acquired.

14. The preference data generation method according to claim 11, wherein the state information is content display screen area display information pertinent to a display state of the content display screen area in the display unit.

15. The preference data generation method according to claim 11, wherein the state information is screen area process state information that is indicative of a process state pertinent to the plurality of screen areas in the information processing apparatus.

16. A computer-readable recording medium having recorded therein a preference data generation program for causing a computer to execute a preference data generation function of generating preference data of a viewer pertinent to a content displayed in a content display screen area that serves as one screen area of a plurality of screen areas displayed on a display unit, the preference data generation program causing the computer to function as:
a state information acquisition unit that acquires state information pertinent to the plurality of screen areas displayed on the display unit;
a preference evaluation value calculation unit that calculates a preference evaluation value pertinent to the content, based on the state information acquired by the state information acquisition unit; and
a preference data generation unit that generates preference data pertinent to the content, based on the preference evaluation value calculated by the preference evaluation value calculation unit.

17. The computer-readable recording medium having a preference data generation program, according to claim 16, wherein the preference data generation program causes the computer to function as a preference reference value calculation unit that calculates a preference reference value pertinent to the content, based on an operation history according to display of the content in the information processing apparatus,
wherein, when the computer is caused to function as the preference data generation unit, the preference data is generated based on the preference reference value calculated by the preference reference value calculation unit and the preference evaluation value calculated by the preference evaluation value calculation unit.
